(19) United States
(12) Patent Application Publication
(10) Pub. No.: US 2025/0303454 A1
(43) Pub. Date: Oct. 2, 2025

(54) ANHYDROUS APPLICATOR CLEAN-OUT TOOL

(71) Applicant: Tyrek Innovations, LLC, Lewistown, MO (US)

(72) Inventor: Richard E. Kempe, Lewistown, MO (US)

(21) Appl. No.: 19/098,462

(22) Filed: Apr. 2, 2025

Related U.S. Application Data
(60) Provisional application No. 63/573,200, filed on Apr. 2, 2024.

(51) Int. Cl. B08B 9/032; B08B 3/04; F16L 47/16

(52) U.S. Cl. CPC B08B 9/0321; B08B 3/04; F16L 47/16

(57) ABSTRACT

An anhydrous applicator clean-out tool that can be used to purge corrosive anhydrous ammonia from an applicator implement. The anhydrous applicator clean-out tool has a hose coupler that attaches to the supply line of an anhydrous applicator. An air compressor or other source of pressurized air is then blown into the line to purge the corrosive anhydrous ammonia. Typically, a protective fluid is poured into the lines, and then purged, to complete the clean-out method.

### CROSS-REFERENCE TO RELATED APPLICATIONS

The present application claims priority from, and incorporates by reference in its entirety, U.S. provisional patent application 63/573,200 filed Apr. 2, 2024.

### BACKGROUND OF THE INVENTION

### Field of the Invention

The present disclosure relates to tools for cleaning equipment containing hazardous materials, for example, a tool that aids in cleaning an anhydrous ammonia fertilizer applicator.

### Description of Related Art

Certain grain crops such corn and wheat deplete nitrogen from the soil. To maintain high crop yields farmers must replenish the nitrogen either through crop rotation or by fertilizing the soil with nitrogen. Liquid anhydrous ammonia (NH₃) fertilizer—which contains 82% nitrogen—is widely used by farmers to increase nitrogen levels in the soil, thus increasing crop yields.

The boiling point of liquid anhydrous ammonia at standard atmospheric pressure is −28 degrees Fahrenheit. Due to its low boiling point liquid anhydrous ammonia immediately evaporates into a highly noxious gas upon being released into the atmosphere. Because of this, farmers must inject the liquid anhydrous ammonia fertilizer down into the soil. This is done with an anhydrous applicator implement 101 as shown in FIG. 1A.

The anhydrous applicator implement 101 has a number of applicator knives 105 (sometimes called shanks) that penetrate the soil. FIG. 1C depicts an applicator knife 105. Each applicator knife 105 has a small metal knife-tube 106 running down along the backside of the applicator knife 105. A hose connects the knife-tube 106 of each knife 105 to a distribution manifold of anhydrous applicator implement 101. The anhydrous ammonia is kept under high pressure in the tank 103 which is pulled behind the applicator implement 101. The anhydrous ammonia flows through main hose coupler 107 and is routed to a flow meter and a control valve. The liquid anhydrous ammonia then flows to the distribution manifold which distributes the liquid anhydrous ammonia fertilizer to the applicator knives 105 as they slice through the soil.

After all their fields have been fertilized with liquid anhydrous ammonia, farmers typically clean the outside of the applicator implement 101 and store it for winter.

### SUMMARY OF THE INVENTION

The present inventor recognized the advantages and benefits of thoroughly cleaning and winterizing the anhydrous applicator implement 101. The various embodiments of the anhydrous applicator clean-out tool according to the present disclosure allow farmers to thoroughly clean and winterize a liquid anhydrous ammonia fertilizer applicator. The various embodiments allow the farmer to use of a great deal of air pressure during the cleaning process, thus ensuring that all the residual anhydrous and foreign materials are flushed out of the system. This helps to maintain and protect the internal parts of the applicator implement 101. In particular, use of the various embodiments of the anhydrous applicator clean-out tool specifically protects the cooler, rate controller, start/stop valves, tube and hose system and the knife-tubes 106. Use of the various embodiments reduces and prevents internal corrosion which aids in winterizing the anhydrous applicator implement 101. Various embodiments of the anhydrous applicator clean-out tool have an easy thread attachment allowing it to be used on any brand of applicator implement 101. The anhydrous applicator clean-out tool serves as a valuable, fractional cost “insurance” to protect the integrity of anhydrous applicator implement 101.

### BRIEF DESCRIPTION OF THE DRAWINGS

Various aspects and advantageous features of the present disclosure will become more apparent to those of ordinary skill in the art from the explanations in the Detailed Description below, and reference to the accompanying drawings, wherein:

FIG. 1A depicts an oblique rear view of an anhydrous ammonia fertilizer applicator implement pulled behind a tractor.

FIG. 1B depicts a rear view of an anhydrous ammonia fertilizer applicator implement.

FIG. 1C depicts an oblique side view of a knife blade for an anhydrous ammonia fertilizer applicator implement.

FIG. 2A depicts a top view of a single-port applicator clean-out tool in accordance with various embodiments disclosed herein.

FIG. 2B depicts a top view of a dual-port applicator clean-out tool in accordance with various embodiments disclosed herein.

FIG. 3 depicts a dual-port applicator clean-out tool connected to two main hose couplers of a two-hose anhydrous ammonia fertilizer applicator implement in accordance with various embodiments disclosed herein.

FIG. 4 is a flowchart of a method of cleaning and winterizing an anhydrous ammonia fertilizer applicator implement in accordance with various embodiments disclosed herein.

### DETAILED DESCRIPTION

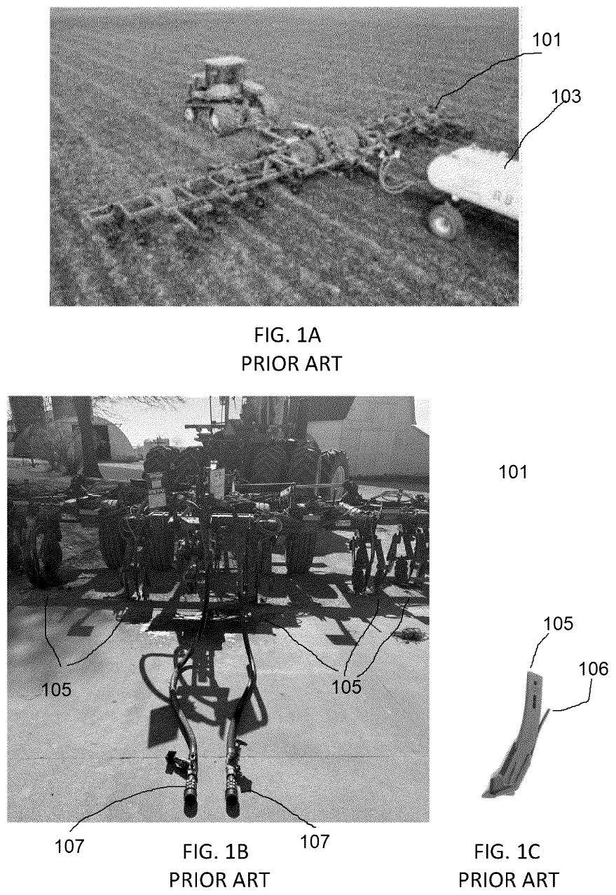

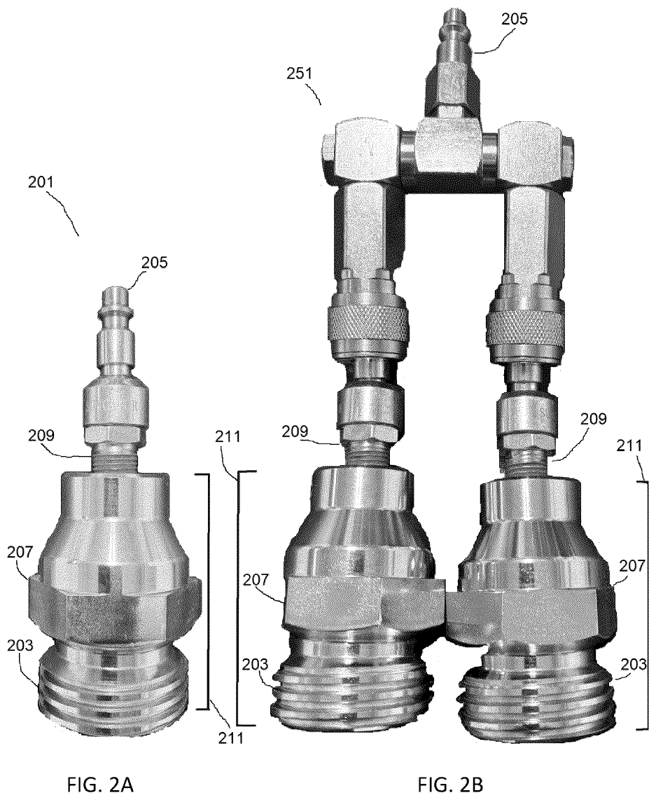

FIG. 2A depicts a top view of a single-port applicator clean-out tool 201 in accordance with various embodiments disclosed herein. The single-port clean-out tool 201 is typically made from a corrosion resistant metal such as galvanized steel or stainless steel, but could be made from other corrosion resistant metals or materials such as brass, copper, polyvinyl chloride (PVC), nylon or other non-corrosive materials of sufficient strength as are known by those of ordinary skill in the art. The single-port clean-out tool 201 has an anhydrous-coupler component 211 that includes a male threaded section 203 and a wrench-flat section 207. The male threaded section 203 has male threads at its proximal end configured to removably connect to the female threads on the anhydrous main hose coupler 107 of FIG. 1B.

The single-port clean-out tool 201 also include a full-swivel fitting 209 which is adjacent to an air-coupler section 205 at the distal end of the single-port clean-out tool 201. The full-swivel fitting 209 connects the air-coupler section 205 to anhydrous-coupler component 211. The full-swivel fitting 209 allows the air-coupler section 205 to move 45 degrees relative to the centerline of anhydrous-coupler component 211. The air-coupler section 205 may be a standard NPT ¼″ male pneumatic fitting or a male industrial quick-connect air-line coupler. The single-port clean-out tool 201 may be fitted with other types and sizes of couplers for air-coupler section 205 to accommodate the source of pressurized air being used.

The wrench-flat section 207 has a hexagonal cross-section configured to receive a wrench. While the single-port clean-out tool 201 may be made from several component parts fitted together with threaded connectors-or in some implementations, welded together-the male threaded section 203 and wrench-flat section 207 are typically formed on the same component-that is, formed from the same piece of metal-so as to ensure structural integrity.

The male threaded section 203 allows a user to connect the single-port clean-out tool 201 to a main hose coupler 107 of an anhydrous applicator implement 101. To ensure an airtight seal, the user can position a wrench on wrench-flat section 207 while tightening the main hose coupler 107. This relieves the strain on the other parts of the single-port clean-out tool 201 and keeps the attached air hose from twisting.

FIG. 2B depicts a top view of a dual-port applicator clean-out tool 251 in accordance with various embodiments disclosed herein. The dual-port applicator clean-out tool 251 can be used to clean and winterize an anhydrous applicator implement 101 with two main hose couplers 107. An attempt to clean only one hose of an anhydrous applicator implement 101 with two main hose couplers 107 would result in the protective solvent fluid flowing through the cooler and out of the unattached hose. The components of dual-port applicator clean-out tool 251 with the same reference labels as those of single-port clean-out tool 201 are the same components. For example, the male threaded section 203 of dual-port applicator clean-out tool 251 is configured the same as the male threaded section 203 a single-port clean-out tool 201.

The dual-port applicator clean-out tool 251 may be made from the same materials as the single-port clean-out tool 201. The dual-port applicator clean-out tool 251 has a left air path and a right air path. Each of the air paths includes an anhydrous-coupler component 211 that includes a male threaded section 203 and a wrench-flat section 207. The male threaded section 203 has male threads at its proximal end configured to removably connect to the female threads on the anhydrous main hose coupler 107 of FIG. 1B.

Each of the air paths of dual-port applicator clean-out tool 251 also include a full-swivel fitting 209 which is adjacent to leg component 213. The full-swivel fitting 209 connects leg component 213 to the anhydrous-coupler component 211. The full-swivel fitting 209 allows the leg component 213 to move 45 degrees relative to the centerline of anhydrous-coupler component 211.

The leg component 213 is connected to a planar-swivel fitting 215. The planar-swivel fitting 215 is a type of fitting that allows each air path to be rotated around 360 degrees within a plane. Planar-swivel fitting 215 and full-swivel fitting 209 are both types of position-adjustable fittings. Other types of position-adjustable fittings known to those of ordinary skill in the art may be used in place of the planar-swivel fittings 215 and full-swivel fittings 209 of applicator clean-out tools 201/251.

Turning again to FIG. 2B, the planar-swivel fitting 215 of both the right and the left air paths connect to an air-coupler section 205. The left path passes through the air-coupler section 205, the left planar-swivel fitting 215, the left a leg component 213, the left full-swivel fitting 209 and the left anhydrous-coupler component 211. Similarly, the right path passes through the air-coupler section 205, the right planar-swivel fitting 215, the right a leg component 213, the right full-swivel fitting 209 and the right anhydrous-coupler component 211. The air-coupler section 205 may be a standard NPT ¼″ male pneumatic fitting or a male industrial quick-connect air-line coupler. The dual-port clean-out tool 251 may be fitted with other types and sizes of couplers for air-coupler section 205 to accommodate the source of pressurized air being used.

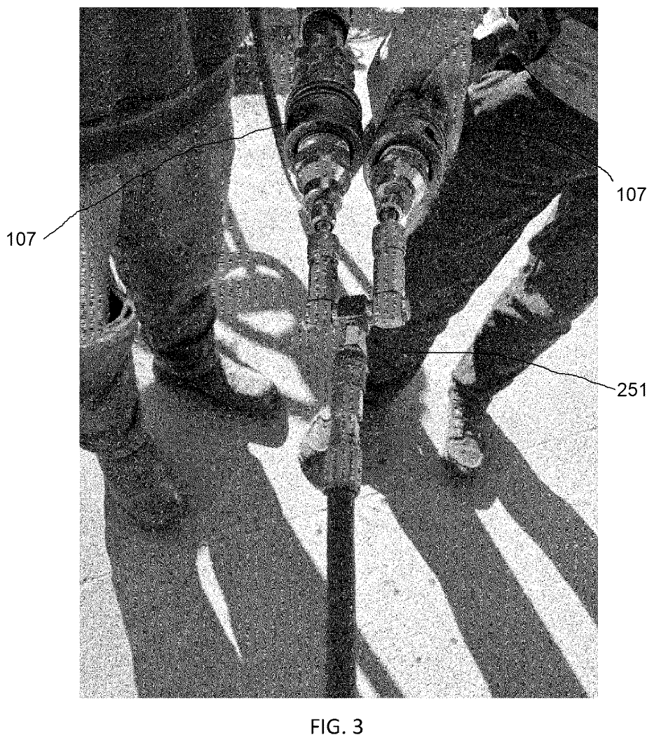

FIG. 3 depicts a dual-port applicator clean-out tool connected to the two main hose couplers 107 of a two-hose anhydrous ammonia fertilizer applicator implement in accordance with various embodiments disclosed herein. An attempt to clean one hose at a time of a two-hose anhydrous applicator implement 101 would result in the protective solvent fluid flowing through the system and out of the unattached hose. Farm equipment has steadily grown larger over the last hundred years. In the future there may be anhydrous applicator implements 101 with more than two hoses. In such an event a multi-port applicator clean-out tool can be configured with the appropriate number of threaded-coupler sections 203 and other component parts to accommodate the multiple main hose couplers 107.

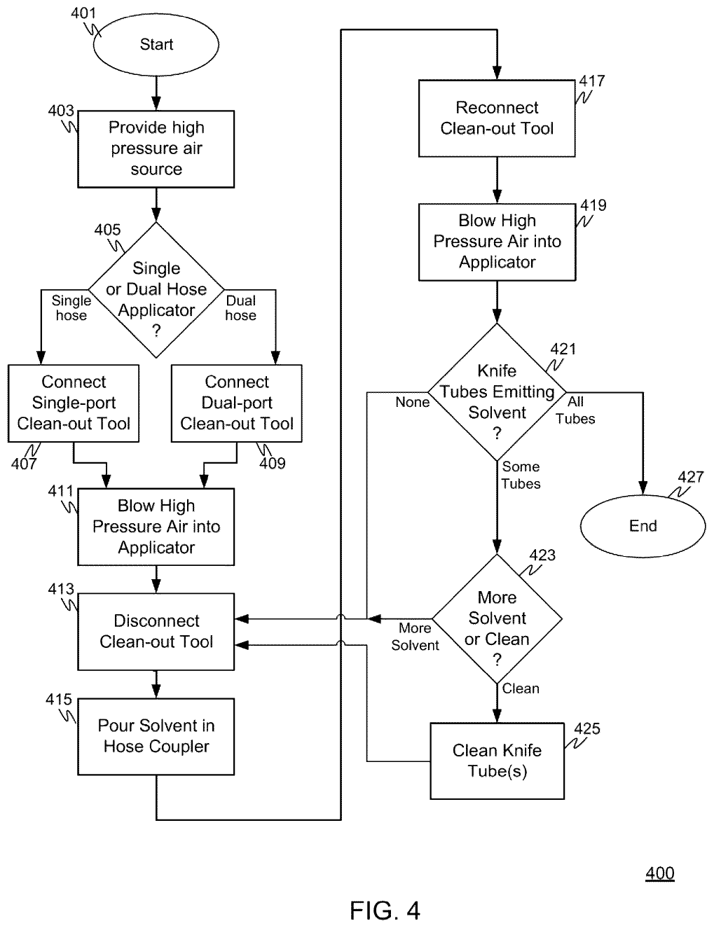

FIG. 4 is a flowchart of a method 400 of cleaning and winterizing an anhydrous ammonia fertilizer applicator implement 101 in accordance with various embodiments disclosed herein. The method begins at block 401 and proceeds to block 403 to provide for a source of high pressure air. The source of high pressure air should have either a female standard NPT ¼″ pneumatic fitting or a female industrial quick-connect air-line coupler to match the male air-coupler section 205. An ordinary farm air compressor is suitable to use in cleaning out an anhydrous ammonia fertilizer applicator implement 101. For example, an eight-gallon, 150 PSI air compressor is suitable. Lower air pressures can be used, but too low of an air pressure reduces the ability to blow the protective solvent fluid through the applicator implement 101. The source of high pressure air is preferably at least 35 PSI. In some embodiments the source of air pressure provides at least 50 PSI. Other embodiments have air pressure of at least 75 PSI, and in yet other embodiments the source of air pressure provides at least 100 PSI. Upon providing a sufficient source of air pressure—e.g., an air compressor—the method proceeds to block 405. It is useful, but not absolutely necessary, to have a valve on the pressurized air source to be able to turn the pressurized air on and off. In the absence of an air valve, the female coupler of the air supply can be connected to male air-coupler section 205 to apply the pressurized air, and disconnected to turn the pressurized air off.

In block 405 it is determined whether the anhydrous applicator implement 101 is a one-hose or a two-hose applicator. For a one-hose anhydrous applicator implement 101 the method proceeds to block 407 and a single-port applicator clean-out tool 201 is connected to the main hose coupler 107 of the anhydrous applicator implement 101. For a two-hose anhydrous applicator implement 101 the method proceeds to block 409 to connect each male threaded section 203 of the dual-port applicator clean-out tool 251 to a respective one of the two the main hose couplers 107 of the two-hose anhydrous applicator implement 101. Once the applicator clean-out tool 201/251 is connected to the anhydrous applicator implement 101 the method proceeds to block 411.

In block 411 the user—e.g., the farmer—applies the pressurized air into main hose coupler(s) 107 of the anhydrous applicator implement 101 to blow out any residual anhydrous, loose dirt, plant stems or other debris or objects that is in the anhydrous lines of the applicator implement 101. The air may be applied for a predefined time period such as at least 10 seconds, at least 30 seconds, at least a minute, or at least two minutes. Alternatively, if the user can see debris or objects coming out of one or more knife-tubes 106 the air can be applied for any of the above time periods after no more debris or objects can be seen coming out of the knife-tubes 106. After the user finishes blowing pressurized air into the anhydrous applicator implement 101 the method proceeds to block 411 where the user disconnects the applicator clean-out tool 201/251 from the main hose coupler(s) 107.

In block 415 the user holds the main hose coupler(s) 107 up to a level higher than the anhydrous applicator implement 101 and pours a predefined amount of liquid solvent into each hose. A funnel may be used to simplify the task. Typically, the predefined amount is at least one-half gallon of protective solvent fluid. But other predefined amounts may be used in the cleaning procedure. The predefined amount may be at least a quart, or may be at least a gallon, or other predefined amount, depending upon the type of protective solvent fluid used. In various embodiments WD40™ is used as a protective solvent fluid. Alternatively, GT85™ or Liquid Wrench™ or other protective solvent fluid known to those of ordinary skill in the art may be used. Once the protective solvent fluid has been poured into the main hose coupler(s) 107, the method proceeds to block 417 to reconnect the applicator clean-out tool 201/251 to the source of high air pressure.

In block 419 high pressure air is again blown into the main hose coupler(s) 107 of the anhydrous applicator implement 101. The residual anhydrous, debris or other objects should have been blown out in block 411, although it is possible that some stubborn debris or object may come out at this time. After a predefined amount of time of blowing the pressurized air into the main hose coupler(s) 107 the method proceeds to block 421. The predefined period of time may be one of those mentioned above for block 411.

At some point the protective solvent fluid will begin coming out of one or more of the knife-tubes 106. However, it sometimes takes more protective solvent fluid than the initial predefined amount. In block 421, if no protective solvent fluid is coming out of the knife-tubes 106 after the predefined amount of time the method proceeds along the “None” path back to block 413 where the applicator clean-out tool 201/251 is disconnected and to block 415 where more protective solvent fluid is poured in. The process of pouring in more protective solvent fluid (415) and blowing it through the hose system of the anhydrous applicator implement 101 (419) may need to be repeated several times before protective solvent fluid is coming out of all the knife-tubes 106.

If it is determined in block 421 that only some of the knife-tubes 106 are emitting protective solvent fluid, the user may opt to proceed along the “Some Tubes” path to block 423. In block 423 it is determined whether the user want to proceed along the “More Solvent” path and add more protective solvent fluid, or proceed along the “Clean” path and proceed to block 425. In block 425 the user cleans the knife-tubes 106 that are not yet emitting protective solvent fluid. This may be done by sticking a wire into the end of knife-tube 106 to loosen any impediments that are stuck close to the end, or by using a small wire brush, or similar tools for cleaning out a small pipe. The user may also blow an air compressor up into the knife-tube 106 in an effort to dislodge any materials that are sticking in the knife-tubes 106 pathway. The user may also disconnect the flexible hose fastened to the knife-tube 106 and clean with a wire or brush down into the knife-tube 106 and up into the flexible hose. Once the knife-tube(s) 106 have been cleaned the method proceeds to block 413 to repeat the process of putting more protective solvent fluid in and blow it through the hose system of the applicator implement 101.

Returning to block 421, if it is determined that protective solvent fluid is flowing out of all the knife-tubes 106 the method proceeds to block 427 and ends.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein to particular optical voltage sensing systems or electro-optic crystal assemblies. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

1. An anhydrous fertilizer applicator clean-out tool apparatus comprising:
an anhydrous-coupler component including a first end and a second end;
a male threaded section configured as part of the anhydrous-coupler component adjacent the first end;
a wrench-flat section configured as part of the anhydrous-coupler component adjacent the male threaded section;
a position-adjustable fitting connected to the anhydrous-coupler component;
an air-coupler section connected to the first end of the anhydrous-coupler component, wherein the air-coupler section is configured to be removably connected to a source of high-pressure air;
wherein an air path of the anhydrous fertilizer applicator clean-out tool passes through the male threaded section, the wrench-flat section, the position-adjustable fitting and the air-coupler section; and
wherein the first end is a distal end of the anhydrous fertilizer applicator clean-out tool.

2. The apparatus of claim 1, wherein the wrench-flat section has a hexagonal cross-section.

3. The apparatus of claim 1, wherein the male threaded section is configured removably connect to female threads on an anhydrous main hose coupler.

4. The apparatus of claim 3, wherein a pressure of the source of high-pressure air is at least 50 PSI.

5. The apparatus of claim 3, wherein a pressure of the source of high-pressure air is at least 100 PSI.

6. The apparatus of claim 3, wherein the position-adjustable fitting is a full-swivel fitting.

7. The apparatus of claim 6, wherein the anhydrous-coupler component is a first anhydrous-coupler component; the male threaded section is a first male threaded section, the wrench-flat section is a first wrench-flat section, and the position-adjustable fitting is a first position-adjustable fitting, the apparatus further comprising:
a second anhydrous-coupler component including a third end and a fourth end;
a second male threaded section configured as part of the second anhydrous-coupler component adjacent the third end;
a second wrench-flat section configured as part of the second anhydrous-coupler component adjacent the second male threaded section; and
a second position-adjustable fitting connected to the second anhydrous-coupler component.

8. The apparatus of claim 7, further comprising:
a third position-adjustable fitting; and
a first leg component connected between the third position-adjustable fitting and the air-coupler section.

9. The apparatus of claim 8, further comprising:
a fourth position-adjustable fitting; and
a second leg component connected between the fourth position-adjustable fitting and the air-coupler section.

10. The apparatus of claim 3, wherein the third position-adjustable fitting and the fourth position-adjustable fitting are planar-swivel fittings.

11. A method of cleaning out an anhydrous fertilizer applicator using a clean-out tool, the method comprising:
configuring an anhydrous-coupler component to have a first end and a second end;
providing a male threaded section configured as part of the anhydrous-coupler component adjacent the first end;
positioning a wrench-flat section adjacent the male threaded section, wherein the wrench-flat section is configured as part of the anhydrous-coupler component;
connecting a position-adjustable fitting to the anhydrous-coupler component;
removably connecting an air-coupler section to a source of high-pressure air, wherein the air-coupler section connected to the first end of the anhydrous-coupler component;
configuring the clean-out tool to have an air path that passes through the male threaded section, the wrench-flat section, the position-adjustable fitting and the air-coupler section;
wherein the first end is a distal end of the clean-out tool.

12. The method of claim 11, wherein the wrench-flat section has a hexagonal cross-section.

13. The method of claim 12, wherein the male threaded section is configured to removably attach to a main coupling hose of the anhydrous fertilizer applicator, the method further comprising:
connecting the male threaded section to the main coupling hose of the anhydrous fertilizer applicator; and
blowing the high-pressure air into the main coupling hose of the anhydrous fertilizer applicator.

14. The method of claim 3, wherein a pressure of the source of high-pressure air is at least 50 PSI, the method further comprising:
disconnecting the male threaded section from the main coupling hose of the anhydrous fertilizer applicator;
pouring a predefined amount of protective solvent fluid into the main coupling hose of the anhydrous fertilizer applicator; and
reconnecting the male threaded section to the main coupling hose of the anhydrous fertilizer applicator.

15. The method of claim 14, wherein the position-adjustable fitting is a full-swivel fitting, the method further comprising:
blowing the predefined amount of protective solvent into the main coupling hose of the anhydrous fertilizer applicator with the high-pressure air.

16. The method of claim 15, wherein the anhydrous-coupler component is a first anhydrous-coupler component; the male threaded section is a first male threaded section, the wrench-flat section is a first wrench-flat section, and the position-adjustable fitting is a first position-adjustable fitting, the method further comprising:
configuring a second anhydrous-coupler component to have a third end and a fourth end;
providing a second male threaded section configured as part of the second anhydrous-coupler component adjacent the third end;
positioning a second wrench-flat section configured as part of the second anhydrous-coupler component adjacent the second male threaded section; and
connecting a second position-adjustable fitting to the second anhydrous-coupler component.

17. The method of claim 6, further comprising:
connecting a third position-adjustable fitting to a first leg component;
connecting the first leg component between the third position-adjustable fitting and the air-coupler section;
connecting a fourth position-adjustable fitting to a second leg component; and
connecting the second leg component connected between the fourth position-adjustable fitting and the air-coupler section.

18. The method of claim 17, wherein the third position-adjustable fitting and the fourth position-adjustable fitting are planar-swivel fittings.
